(19) United States
(12) Patent Application Publication
(10) Pub. No.: US 2013/0325192 A1
(43) Pub. Date: Dec. 5, 2013

(54) SYSTEM AND METHOD FOR ESTABLISHING ACTIVITY BASED ENVIRONMENTAL CONTROL

(71) Applicant: Rajendra K. Shah, Indianapolis, IN (US)

(72) Inventor: Rajendra K. Shah, Indianapolis, IN (US)

(73) Assignee: Carrier Corporation, Farmington, CT (US)

(21) Appl. No.: 13/990,892

(22) PCT Filed: Feb. 13, 2012
(86) PCT No.: PCT/US12/24808

§ 371 Date: May 31, 2013

Related U.S. Application Data
(60) Provisional application No. 61/442,521, filed on Feb. 14, 2011.

(51) Int. Cl. G05D 23/19

(52) U.S. Cl. CPC G05D 23/19
USPC 700/276

(57) ABSTRACT

A method for establishing activity based environmental control includes selecting an activity phase, associating a plurality of environmental parameters with the activity phase, defining a time period for the activity phase, and controlling at least one environmental control device to establish the plurality of environmental parameters in an environmental zone during the time periods associated with the activity phase.

### CROSS REFERENCE TO RELATED APPLICATIONS

This application is a National Stage Application of PCT Application No. PCT/US12/024808 filed Feb. 13, 2012, which is a PCT Application of U.S. Provisional Patent Application No. 61/442,521 filed Feb. 14, 2011, the disclosures of which are incorporated by reference herein in their entireties.

### BACKGROUND OF THE INVENTION

Exemplary embodiments pertain to the art of environmental control devices and, more particularly, to a system and method for establishing activity based environmental control of a space.

Environmental controls have evolved over time from simple temperature based controls to more conventional programmable controls. Programmable controls allow users to set a particular temperature in an area for a particular time of day. More specifically, programmable controls or thermostats enable users to program a schedule of temperature set points for a fixed number of time periods over the course of a day. In some cases, a different schedule may be programmed for different days. Existing controls include rigid time periods. For example, a thermostat may include four sequential time periods, WAKE, AWAY, HOME, and SLEEP. That is, the time periods progress, in order, from WAKE through SLEEP. More specifically, the AWAY time period cannot be programmed for a time period that is earlier than the time period associated with WAKE; the HOME time period cannot be programmed for a time period that is earlier than the time period associate with AWAY; and the SLEEP control phase can not be programmed for a time period that is earlier than any of the other time periods. For each time period, the user may set a specific start time, and desired temperature. During each time period, the thermostat operates a heating/cooling system to establish the desired temperature.

### BRIEF DESCRIPTION OF THE INVENTION

Disclosed is a method for establishing activity based environmental control. The method includes selecting an activity phase, associating a plurality of environmental parameters with the activity phase, defining a time period for the activity phase, and controlling at least one environmental control device to establish the plurality of environmental parameters in an environmental zone during the time periods associated with the activity phase.

Also disclosed is a programmable control unit including an activity phase register configured and disposed to store an activity phase having associated therewith a plurality of environmental parameters, a time period register configured and disposed to establish a time period for the activity phase, and a controller operatively coupled to the activity phase register, the time period register and configured and disposed to communicate with at least one environmental control device, the controller being configured and disposed to selectively activate the at least one environmental control device to establish the plurality of environmental parameters associated with the activity phase during the time period.

Further disclosed is an environmental control system including a temperature control system, a humidity control system, an air flow control system, and a programmable control unit operatively connected to each of the temperature control system, humidity control system, and air flow control system. The programmable control unit includes an activity phase register configured and disposed to store an activity phase having associated therewith at least two of a temperature parameter, a humidity parameter and an air flow parameter, a time period register configured and disposed to establish a time period for the activity phase, and a controller operatively coupled to the activity phase register, time period register, and each of the temperature control system, humidity control system and air flow control system. The controller is configured and disposed to selectively activate select ones of the temperature control system, humidity control system and air flow control system to establish the at least two of the temperature parameter, humidity parameter, and air flow parameter associated with the activity phase during the time period.

### BRIEF DESCRIPTION OF THE DRAWINGS

The following descriptions should not be considered limiting in any way. With reference to the accompanying drawings, like elements are numbered alike:

FIG. 1 is a schematic view of an environmental control system including a programmable control unit in accordance with an exemplary embodiment;

FIG. 2 is a flow diagram illustrating a method of establishing an activity based environmental control for the programmable control unit in accordance with the exemplary embodiment;

FIG. 3 illustrates environmental control parameter options for an activity phase in accordance with an exemplary embodiment;

FIG. 4 is a schematic view of a display screen of the programmable control unit illustrating a first activity based control scheme;

FIG. 5 is a schematic view of a display screen of the programmable control unit illustrating a second activity based control scheme;

FIG. 6 is a schematic view of a display screen of the programmable control unit illustrating a third activity based control scheme; and

FIG. 7 is a schematic view of a display screen of the programmable control unit illustrating a fourth activity based control scheme.

### DETAILED DESCRIPTION OF THE INVENTION

A detailed description of one or more embodiments of the disclosed apparatus and method are presented herein by way of exemplification and not limitation with reference to the Figures.

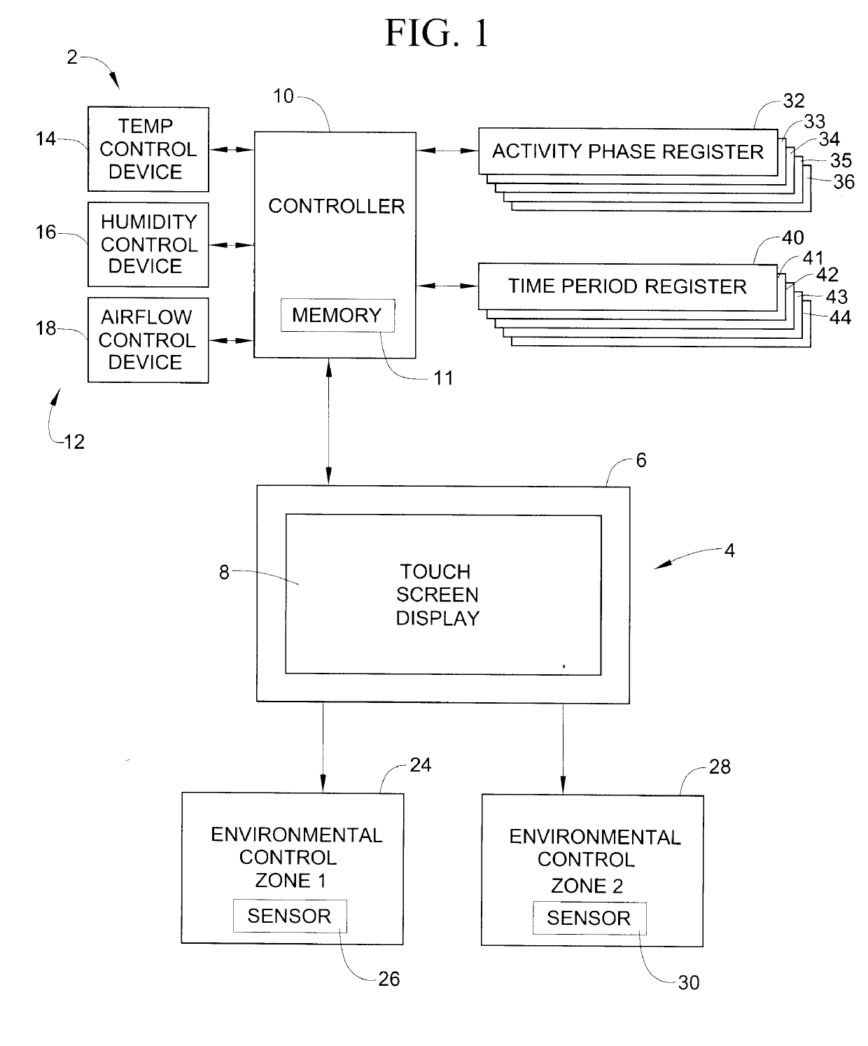

With reference to FIG. 1, an environmental control system in accordance with the exemplary embodiment is indicated generally at 2. Environmental control arrangement 2 includes a programmable control unit 4. Programmable control unit 4 includes a housing 6 and a user input/output device shown in the form of a touch screen display 8 that allows a user to establish and view various environmental control parameters for one or more environmental control zones as will be detailed more fully below. Programmable control unit 4 also includes a controller 10 having a memory 11. Programmable control unit is operatively connected to a plurality of environmental control devices 12. Memory 11 that stores various programs for controller 10 as will be discussed more fully below. Environmental control devices 12 include a temperature control system 14, such as a gas furnace, air conditioner, and/or heat pump; a humidity control system 16; and an airflow control system 18. It should be understood that the number and type of environmental control devices can vary. Programmable control unit 4 is configured to establish desired environmental parameters, e.g., temperature, humidity, and/or airflow for a first environmental control zone 24 having a first sensor 26, and a second environmental control zone 28 having a second sensor 30. At this point it should be understood that while shown with touch screen display 8, programmable control unit 4 can be provided with other mechanisms that accept user inputs such as buttons or key pads in combination with a liquid crystal display (LCD) screen that displays current and desired temperature information. Also, while shown with an integrated controller, programmable control unit 4 could be operatively connected to a controller located remote from housing 6.

Each sensor 26, 30 provides environmental parameter data from respective ones of first and second environmental control zones 24 and 28 to programmable control unit 4. In accordance with the exemplary embodiment, a user is provided with an option of establishing activity based environmental control parameters for first and/or second environmental control zone 26, 28 as will be discussed more fully below. More specifically programmable environmental control 4 includes a plurality of activity registers 32-36 that are configured to store various environmental parameters, and a plurality of time period registers 40-44 that are associated with select ones of activity registers 32-36. At this point it should be understood that activity based environmental control should be understood to mean that a user can program various environmental factors for specific activities which are then assigned a desired time period. The user is not limited to selecting only a desired temperature for a series sequentially running time periods as provided in the prior art arrangements.

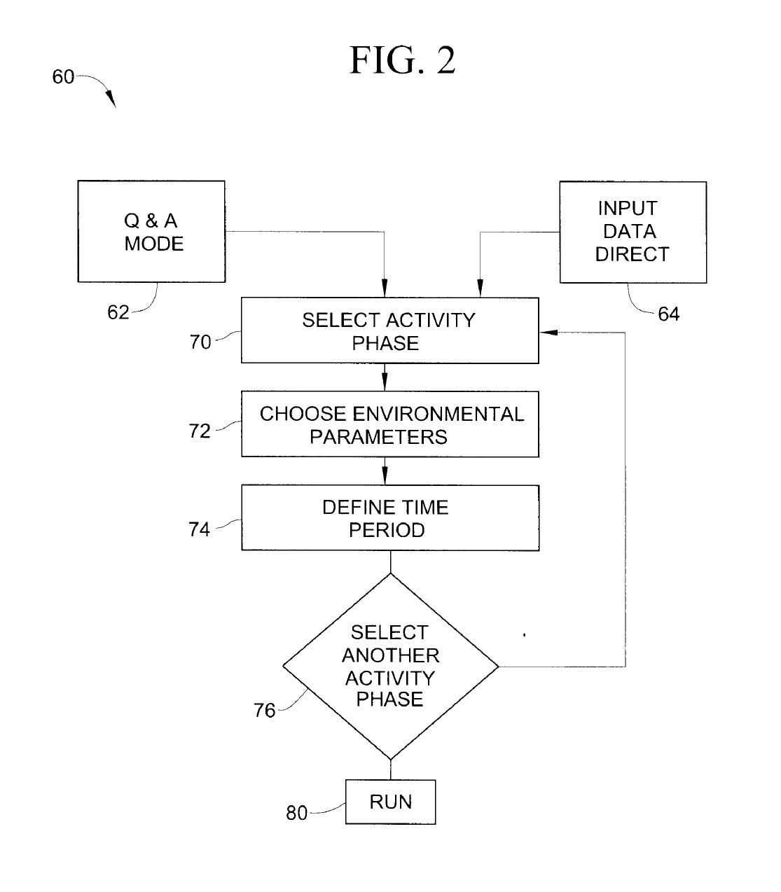

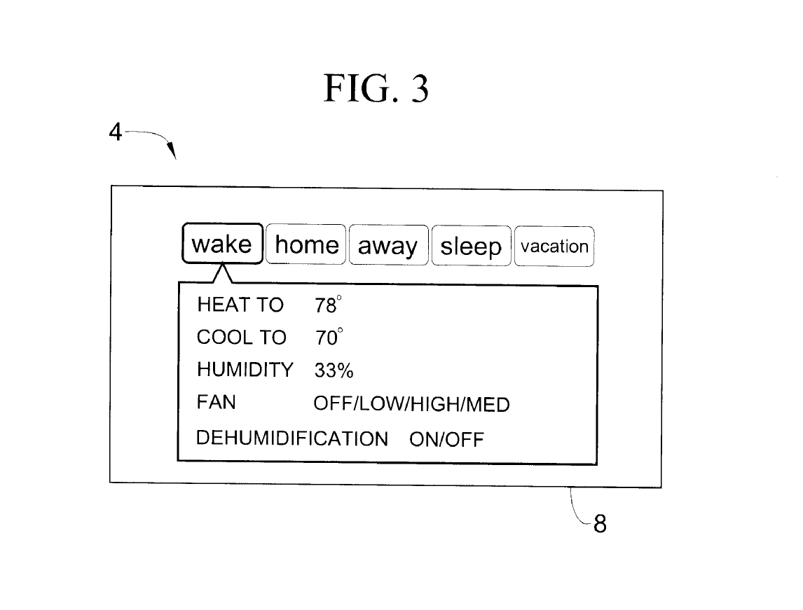

Reference will now be made to FIG. 2 in describing a method 60 of establishing activity based environmental control for programmable control unit 4. A user has an option of entering activity parameter data through either a question and answer mode as indicated in block 62 or directly into activity registers 32-36 as indicated in block 64. If directly inputting activity data, the user initially selects a first activity phase such as WAKE as indicated in block 70. At this point, the user establishes desired environmental control parameters for WAKE as indicated in block 72. For example, a user may select desired temperature, humidity, dehumidification, and/or fan options for WAKE such as shown in FIG. 3. After selecting the environmental control parameters, the user assigns or defines a time period for the activity phase as indicated in block 74. The time period may represent all or part of a day as will be detailed more fully below. The time period may be different from day to day as will also be described more fully below. In any case, assigning or defining a time period should be understood to include selecting a start time, establishing start and end times, or simply selecting an activity phase for an indefinite time period. At this point, the user has the option of selecting another activity in block 76. In accordance with one aspect of the exemplary embodiment, the user may set environmental control parameters for HOME, AWAY, SLEEP, and VACATION activity phases in addition to WAKE. The number of activity phases, and activity phase descriptions (labels) can vary. In addition, a user may be provided with an option of assigned unique labels to one or more of activity registers 32-36. After setting up each desired activity phase, method 60 is saved in memory 11 as a set of computer readable instructions in memory and subsequently selectively executed or run by controller 10 as indicated in block 80.

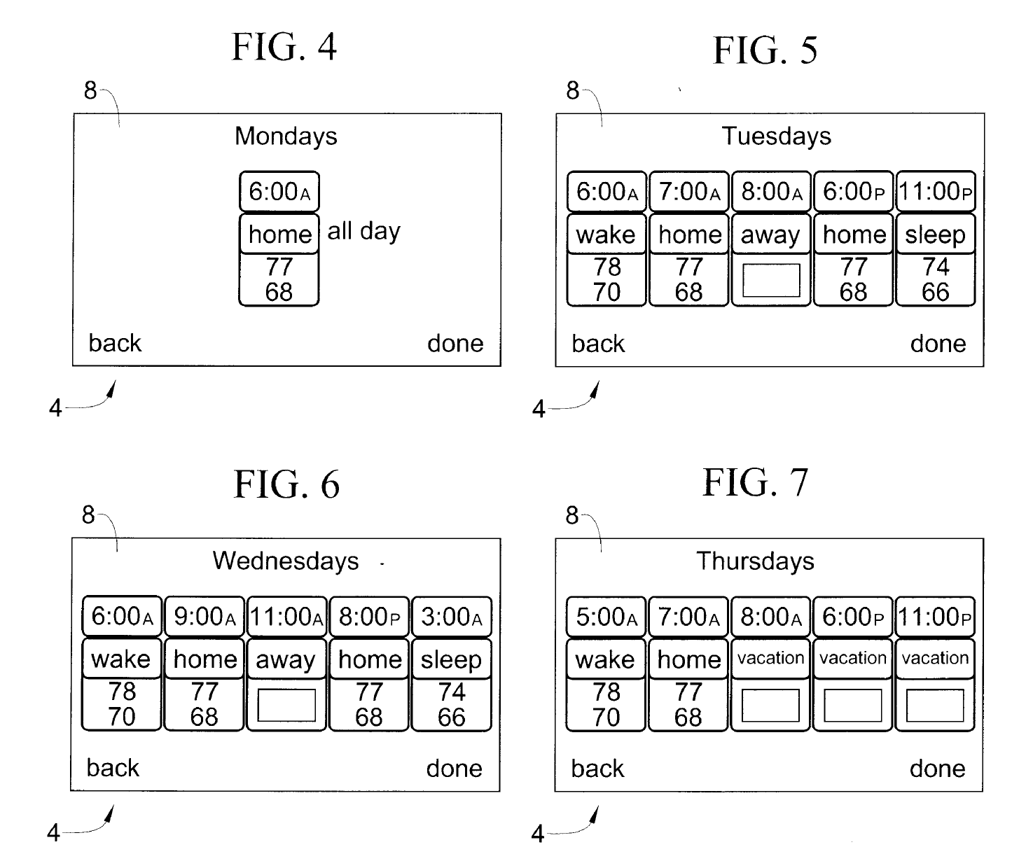

Reference will now be made to FIGS. 4-7 in describing various examples of activity based environmental control in accordance with the exemplary embodiment. As shown, a user has established five activity phases each having associated therewith environmental control parameters. FIG. 4 illustrates activity based control for Monday. On Monday, the user has established a time period for a single activity phase, namely HOME, to initiate at 6:00 am. As such, programmable control unit will selectively activate environment control system 12 to establish the desired environmental control parameters for HOME. For Tuesday, illustrated in FIG. 5, the user has assigned time periods to four activity phases, namely, WAKE, HOME, AWAY, and SLEEP. For Wednesday, illustrated in FIG. 6, the user has programmed different time periods for the WAKE, HOME, AWAY, and SLEEP user defined activity phases. Thursday, illustrated in FIG. 7 shows that the user has programmed three time periods, two for WAKE and HOME, and the third for VACATION. In this manner, the user can tailor desired environmental parameters to meet his/her individual needs for any given day. More over, the user can assign different time periods for each activity phase for each environmental control zone. For example, in environmental control zone 24, the user may assign 6:00 am to WAKE, but environmental control zone 28 can be assigned SLEEP, AWAY or HOME for the same time period. This provides the user even greater flexibility to establish comfortable, and or energy saving environmental parameters for a home.

At this point it should be understood that the exemplary embodiment provides a system for programming activity based environmental factors for one or more environmental control zones. Activity based programming allows a user to establish various environmental factors, e.g., temperature, humidity, air flow, for one or more activities. The user then has the flexibility to assign each activity to independent time periods in a 24-hour period, but to different time periods for each day of a week. In this manner, the user can easily establish desired comfort levels for his/her home.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A method for establishing activity based environmental control, the method comprising:
selecting an activity phase;
associating a plurality of environmental parameters with the activity phase;
defining a time period for the activity phase; and
controlling at least one environmental control device to establish the plurality of environmental parameters in an environmental zone during the time period associated with the activity phase.

2. The method of claim 1, further comprising:
selecting a plurality of activity phases;
defining a time period for each of the plurality of activity phases, the time period for one of the plurality of activity phases being independent from time periods associated with each of the other activity phases.

3. The method of claim 2, further comprising: selecting a plurality of environmental parameters for each of the plurality of activity phases.

4. The method of claim 2, further comprising: defining multiple time periods for one of the plurality of activity phases.

5. The method of claim 4, wherein defining multiple time periods for one of the plurality of activity phases includes defining a first time period for one of the plurality of activity phases, defining a second time period for another of the plurality of activity phases, and defining a third time period for the one of the plurality of activity phases, the first time period being earlier than the second time period, and the third time period being later than the second time period.

6. The method of claim 1, further comprising: defining a first time period for the activity phase in a first environmental control zone and a second time period for the activity phase in a second environmental control zone.

7. The method of claim 1, wherein associating the plurality of environmental parameters with the activity phase includes responding to questions presented on a display.

8. The method of claim 1, wherein associating the plurality of environmental parameters with the activity phase includes inputting environmental parameter selections through a touch screen display.

9. The method of claim 1, associating the plurality of environmental parameters with the activity phase includes selecting at least two of a temperature parameter, a humidity parameter and an air flow parameter for the activity phase.

10. The method of claim 1, wherein defining the time period for the activity phase includes defining multiple independent time periods for the activity phase in a twenty four hour period.

11. A programmable control unit comprising:
an activity phase register configured and disposed to store an activity phase having associated therewith a plurality of environmental parameters;
a time period register configured and disposed to establish a time period for the activity phase; and
a controller operatively coupled to the activity phase register, the time period register, and configured and disposed to communicate with at least one environmental control device, the controller being configured and disposed to selectively activate the at least one environmental control device to establish the plurality of environmental parameters associated with the activity phase during the time period.

12. The programmable control unit according to claim 11, wherein the activity phase register comprises a plurality of activity phase registers, each of the plurality of activity phase registers being configured and disposed to store a plurality of environmental parameters.

13. The programmable control unit according to claim 12, wherein the plurality of activity phase registers include a WAKE phase, an AWAY phase, a HOME phase, a SLEEP phase, and a VACATION phase.

14. The programmable control unit according to claim 12, wherein the time period register includes a plurality of time period registers associated with one or more of the plurality of activity registers.

15. The programmable control unit according to claim 14, wherein two of the plurality of time period registers are associated with a single one of the plurality of activity registers.

16. The programmable control unit according to claim 11, further comprising: a touch screen display, the touch screen display being operably connected to the controller, the activity phase register and the time period register.

17. The programmable control unit according to claim 11, wherein the controller is configured and disposed to selectively activate the at least one environmental control device to establish the plurality of environmental parameters associated with the activity phase during the time period in a first environmental zone and to establish the plurality of environmental parameters associated with the activity phase during another time period in a second environmental zone.

18. An environmental control system comprising:
a temperature control device;
a humidity control device;
an air flow control device; and
a programmable control unit operatively connected to each of the temperature control device, humidity control device, and air flow control device, the programmable thermostat including:
an activity phase register configured and disposed to store at an activity phase having associated therewith at least two of a temperature parameter, a humidity parameter and an air flow parameter;
a time period register configured and disposed to establish a time period for the activity phase; and
a controller operatively coupled to the activity phase register, time period register, and each of the temperature control device, humidity control device and air flow control device, the controller being configured and disposed to selectively activate select ones of the temperature control device, humidity control device and air flow control device to establish the at least two of the temperature parameter, humidity parameter, and air flow parameter associated with the activity phase during the time period.

19. The environmental control system according to claim 18, wherein the activity phase register comprises a plurality of activity phase registers, each of the plurality of activity phase registers being configured and disposed to store two or more of the temperature parameter, humidity parameter, and air flow parameter.

20. The environmental control system according to claim 18, wherein the time period register includes a plurality of time period registers associated with one or more of the plurality of activity registers, at least two of the plurality of time period registers being associated with a single one of the plurality of activity registers.
